(19) United States
(12) Patent Application Publication
(10) Pub. No.: US 2026/0079655 A1
(43) Pub. Date: Mar. 19, 2026

(54) IMAGE FORMATION APPARATUS, IMAGE FORMATION METHOD, AND COMPUTER-READABLE STORAGE MEDIUM

(71) Applicant: CANON KABUSHIKI KAISHA, Tokyo (JP)

(72) Inventor: YUJI KIYOTA, Kanagawa (JP)

(21) Appl. No.: 19/325,699

(22) Filed: Sep. 11, 2025

(30) Foreign Application Priority Data
Sep. 13, 2024 (JP) 2024-159207

(51) Int. Cl. G06F 3/12

(52) U.S. Cl. CPC G06F 3/1218; G06F 3/125; G06F 3/1256

(57) ABSTRACT

An image formation apparatus includes: one or more processors; and one or more memories storing instructions that, when executed by the one or more processors, cause the image forming apparatus to: determine a split number of a document image that is required to enlarge and split the document image and perform duplication printing on a printing medium based on a size of the printing medium and a split enlargement direction of the document image; and notify a user of the split number determined by the determination unit before accepting an instruction to execute the duplication printing.

### BACKGROUND

### Field of the Technology

The present disclosure relates to enlarged printing of a printing medium.

### Description of the Related Art

Conventionally, a technique of creating a large print product such as a poster by enlarging one page of an image, printing the image by splitting into multiple sheets, and pasting the printed multiple sheets together has been known.

Japanese Patent Laid-Open No. 2002-283645 (hereinafter, referred to as PTL 1) describes a technique of enlarging an image of an image file and printing the image separately on multiple printing media. Additionally, PTL 1 also describes a technique of providing a pasting guide, which is to paste together the multiple printing media obtained by splitting the enlarged single image, to a peripheral edge part of each printing medium.

### SUMMARY

An image formation apparatus according to an aspect of the present disclosure includes: a determination unit configured to determine a split number of a document image that is required to enlarge and split the document image and perform duplication printing on a printing medium based on a size of the printing medium; and a notification unit configured to notify a user of the split number determined by the determination unit before performing the duplication printing.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an appearance example of an image formation apparatus according to a first embodiment.

FIG. 2 is an enlarged front view of an operation unit in FIG. 1.

FIG. 3 is a block diagram illustrating a configuration of a control system of the image formation apparatus in FIG. 1.

FIG. 4 is a diagram illustrating a display example of a display unit in FIG. 2.

FIG. 5 is a diagram schematically describing a series of steps from splitting the document into halves, enlarged-printing and pasting together the split images, and generating the final deliverable by the image formation apparatus 1 in FIG. 1. FIG. 5(a) is a diagram illustrating an example of a cut paper document image generated by reading a cut paper document by a scanner. FIG. 5(b) is a diagram illustrating an example of the split and enlarged cut paper document image in FIG. 5(a). FIG. 5(c) is a diagram illustrating an example of a final deliverable obtained by pasting together the enlarged printed images in FIG. 5(b).

FIG. 6 is a diagram schematically describing a series of steps from splitting the document into thirds, enlarged-printing and pasting together the split images, and generating the final deliverable by the image formation apparatus 1 in FIG. 1. FIG. 6(a) is a diagram illustrating an example of the cut paper document image generated by reading the cut paper document by the scanner. FIG. 6(b) is a diagram illustrating an example of the split and enlarged cut paper document image in FIG. 6(a). FIG. 6(c) is a diagram illustrating an example of the final deliverable obtained by pasting together the enlarged printed images in FIG. 6(b).

FIG. 7 is a diagram illustrating a combination example of a roll paper size and a split enlargement method used in enlarged printing.

FIG. 8 is a diagram illustrating a display switch example of a printing icon 803 in a case of switching from short side split setting to long side split setting. FIG. 8(a) is a diagram illustrating an example of a window displaying printing setting information. FIG. 8(b) is a diagram illustrating an example of a printing setting window displayed by which a printing setting button in FIG. 8(a) is pressed. FIG. 8(c) is a diagram illustrating an example of a split method setting window. FIG. 8(d) is a diagram illustrating an example of the window after updating the printing setting information.

FIG. 9 is a flowchart describing display processing of a printing icon according to the selection in FIG. 8.

FIG. 10 is a diagram illustrating a display switch example of the printing icon according to the second embodiment. FIG. 10(a) is a diagram illustrating an example of a window displaying the printing setting information. FIG. 10(b) is a diagram illustrating an example of a setting item window displayed by which a split switch button in FIG. 10(a) is pressed. FIG. 10(c) is a diagram illustrating an example of the split method setting window. FIG. 10(d) is a diagram illustrating an example of the window after updating the printing setting information.

FIG. 11 is flowchart describing display processing of the printing icon according to the selection in FIG. 10.

FIG. 12 is a diagram illustrating a display switch example of the printing icon according to the third embodiment. FIG. 12(a) is a diagram illustrating an example of the window displaying the printing setting information. FIG. 12(b) is a diagram illustrating an example of the setting item window displayed by which the split switch button in FIG. 12(a) is pressed. FIG. 12(c) is a diagram illustrating an example of a split number change window. FIG. 12(d) is a diagram illustrating an example of a printing sheet size setting window. FIG. 12(e) is a diagram illustrating an example of a split number display window. FIG. 12(f) is a diagram illustrating an example of the window after updating the printing setting information.

FIG. 13 is a flowchart describing display processing of the printing icon according to the selection in FIG. 12 illustrating a display switch example of the printing icon according to the fourth embodiment.

FIG. 14(a) is a diagram illustrating an example of the window displaying the printing setting information. FIG. 14(b) is a diagram illustrating an example of the setting item window displayed by which the split switch button in FIG. 14(a) is pressed. FIG. 14(c) is a diagram illustrating an example of a setting change guide window. FIG. 14(d) is a diagram illustrating an example of a setting change window. FIG. 14(e) is a diagram illustrating an example of the printing sheet size setting window and the split method setting window. FIG. 14(f) is a diagram illustrating an example of the split number display window. FIG. 14(g) is a diagram illustrating an example of the window after updating the printing setting information.

FIG. 15 is a flowchart describing display processing of the printing icon according to the selection in FIG. 14.

FIG. 16 is a flowchart describing display processing of the printing icon according to a modification.

### DESCRIPTION OF THE EMBODIMENTS

Hereinafter, embodiments of the present disclosure will be described in detail in reference to the attached drawings. The following embodiments are not intended to limit the matters disclosed herein. In addition, all the combinations of features described in the following embodiments are not necessarily essential for the solution of the present disclosure. Herein, the same constituent elements will be designated with the same reference sign.

### Overview

In a case of duplication printing, an enlarged printing function to create a single print product by enlarging a document image read by scanning, printing the image by splitting into multiple printing media, and pasting the printing media together has been known. In the enlarged printing function for roll paper out of printing media, printing is performed by setting an output sheet size within a size range of the roll paper to be disposed. Additionally, it is necessary in a case of the enlarged printing to set a direction to split the printing medium. Depending on the output sheet size and the split direction, the printing number of the printing media obtained from the roll paper is changed. In order to switch the split direction, the user selects whether to split in a long side part or a short side part of the image to be enlarged, and an image formation apparatus changes the split number according to the split direction.

In general duplication printing, after reading the document image that is to be enlarged-printed, the split number is calculated based on the sheet size after the enlarged printing and the split direction, and the split number is displayed substantially as the remaining printing number in a timing of ongoing printing. Thus, it has been a state in which the user is substantially notified of the split number after the printing processing is actually started, and it has been impossible for the user to know whether the splitting is performed with the desired split number before the printing starts.

Note that, as described above, even in a mode of printing as a pasting guide, it has been impossible to adopt the notification to the user of the split number before the enlarged printing. In the present disclosure, the split number is determined before starting the printing in a case of the duplication printing, and the user is notified of the determined split number. According to the operation, it is possible to avoid reprinting.

### First Embodiment

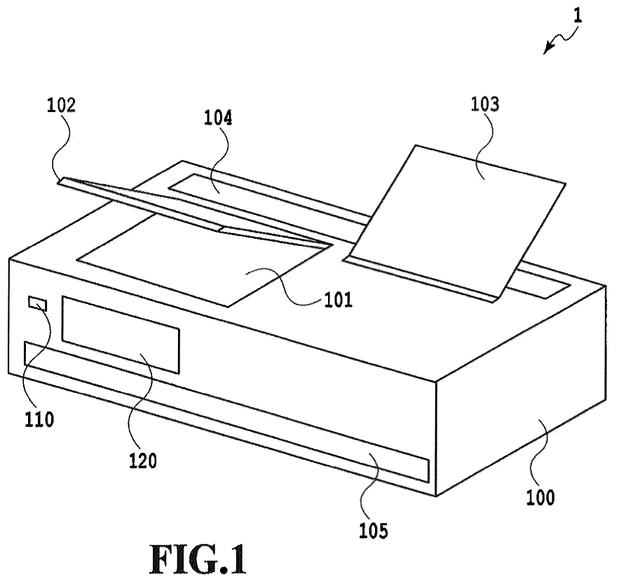

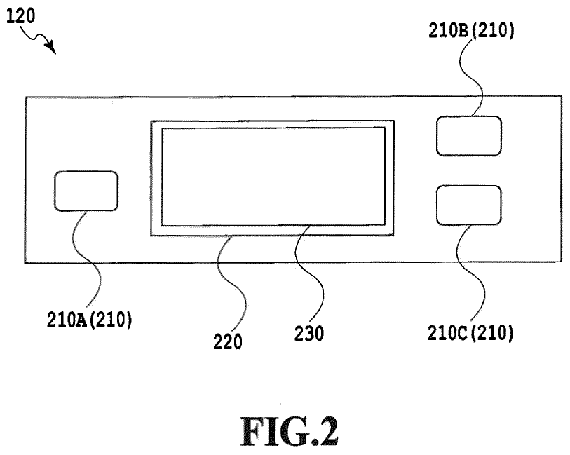

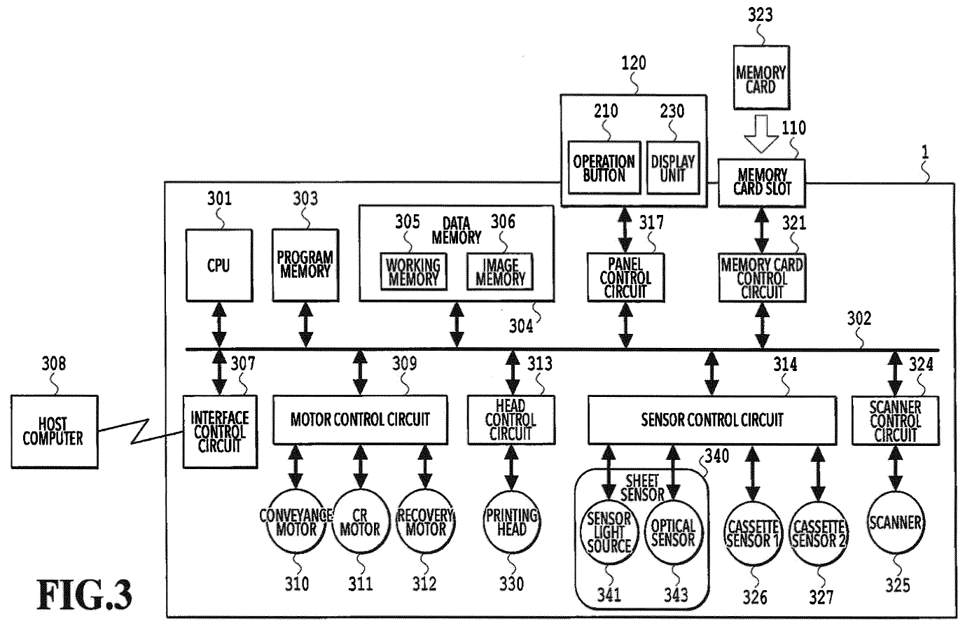

FIG. 1 is a diagram illustrating an appearance example of an image formation apparatus 1 according to a first embodiment. FIG. 2 is an enlarged front view of an operation unit 120 in FIG. 1. FIG. 3 is a block diagram illustrating a configuration of a control system of the image formation apparatus 1 in FIG. 1. As illustrated in FIG. 1, a platen glass 101, a roll paper feed unit 104, and a cut paper feed unit 103 are provided to a top portion of a housing 100 of the image formation apparatus 1. A memory card slot 110, the operation unit 120, and a discharge tray 105 are provided to a front portion of the housing 100 of the image formation apparatus I. The platen glass 101 is a glass like transparent table. A scanner 325 in FIG. 3 is provided below the platen glass 101. An openable and closable document lid 102 is provided to the platen glass 101. The scanner 325 reads a document in a state in which the document is placed on the platen glass 101. The document lid 102 prevents the scanner light from leaking outside while the scanner 325 reads the document. Thus, the image formation apparatus 1 in FIG. 1 is illustrated as an example of a multi function printer having a reading function such as the scanner 325 in FIG. 3.

An insertion slot of cut paper is provided to the cut paper feed unit 103. A size and a shape of the insertion slot of the cut paper correspond to various sizes of the cut paper. The cut paper is set in the cut paper feed unit 103 as the printing medium. For example, it is possible to set printing media having a finished dimension compliant with various standards in the cut paper feed unit 103. The various standards of the cut paper include standards such as “A” series, “B” series, and ANSI, for example. ANSI includes the standard of LTR that is standardized as ANSI A, for example. An insertion slot of roll paper is provided to the roll paper feed unit 104. A size and a shape of the insertion slot of the roll paper correspond to various sizes of the roll paper. The roll paper is set in the roll paper feed unit 104 as the printing medium. For example, it is also possible to set printing media having a finished dimension compliant with various standards in the roll paper feed unit 104. The various standards of the roll paper include an A1 roll, an A2 roll, a 24 inch roll, an 18 inch roll, and a 17 inch roll, for example. Note that, it is possible to set the cut paper in the cut paper feed unit 103 and set the roll paper in the roll paper feed unit 104 concurrently. The printing medium set in the cut paper feed unit 103 or the roll paper feed unit 104 is conveyed to a printing unit including a printing head 330 in FIG. 3 to perform printing on the printing medium, and the printing medium is discharged from the discharge tray 105 in FIG. 1. The memory card slot 110 and the operation unit 120 are provided above the discharge tray 105. An insertion slot of a memory card 323 is provided to the memory card slot 110. With the memory card 323 being inserted into the memory card slot 110, it is possible to read image data stored in the memory card 323 and execute printing of the read image data. The operation unit 120 is a user interface that accepts an operation from the user. According to the operation by the user accepted by the operation unit 120, inputs of various setting values are accepted, and execution of various types of processing is started. Note that, although an inkjet type is assumed in the present embodiment, it is not particularly limited thereto. An electrophotographic type may be applied.

FIG. 2 is the enlarged front view of the operation unit 120 in FIG. 1. As illustrated in FIG. 2, the operation unit 120 includes a power supply button 210A, a stop button 210B, a start button 210C, a display unit 230, and a touch panel unit 220. The display unit 230 displays a graphical user interface (hereinafter, referred to as a GUI). The display unit 230 is formed of a glass panel, for example. The touch panel unit 220 is laminated on a back surface of the display unit 230. The touch panel unit 220 is formed of a touch panel, a liquid crystal panel, and the like. The touch panel unit 220 accepts an operation of the GUI. The display unit 230 displays a status of the image formation apparatus 1, a printing setting value, an image preview read from the memory card, and the like in the form of the GUI. The status of the image formation apparatus 1 is, for example, ink information or information of the stored printing medium. The ink information is, for example, information indicating a type of an ink such as cyan, magenta, yellow, and black and the remaining amount of the ink. The information of the printing medium is, for example, information indicating the size of the roll paper stored in the roll paper feed unit 104. The size of the roll paper includes, for example, the 18 inch roll, the 24 inch roll, the A1 inch roll, and the A2 inch roll. The touch panel unit 220 accepts the operation from the user on the GUI displayed on the display unit 230. For example, the user can change printing setting and the like via the touch panel unit 220. Additionally, it is possible to accept the operation from the user via a unit other than the touch panel unit 220. For example, once the user presses the power supply button 210A, power supply to the image formation apparatus 1 is inputted or disconnected. Once the user presses the start button 210C, an operation (copying and printing) of the image formation apparatus 1 is started. The operation of the image formation apparatus 1 is duplicating or printing of the image data on the printing medium, for example. Once the user presses the stop button 210B, the operation on the image formation apparatus 1 is canceled, or the operation of the image formation apparatus 1 is stopped. Note that, in a case where the various buttons such as the power supply button 210A, the stop button 210B, and the start button 210C in FIG. 2 are collectively called, they are referred to as an operation button 210. Note that, the operation button 210 illustrated in FIG. 2 is an example and is not particularly limited thereto. Additionally, the GUI corresponding to the operation button 210 may be displayed on the display unit 230, or the GUI corresponding to the operation button 210 may be operated by the user via the touch panel unit 220.

FIG. 3 is the block diagram illustrating the configuration of the control system of the image formation apparatus 1 in FIG. 1. As the configuration of the control system, the image formation apparatus 1 includes a CPU 301, a program memory 303, a data memory 304, a panel control circuit 317, a memory card control circuit 321, and an internal bus 302. The CPU 301, the program memory 303, the data memory 304, the panel control circuit 317, and the memory card control circuit 321 are connected to each other via the internal bus 302. For example, the CPU 301 executes processing according to a storage content of the program memory 303 in the form of a ROM and a storage content of the data memory 304 in the form of a RAM via the single internal bus 302. The data memory 304 is utilized as a working memory 305 or an image memory 306. The working memory 305 can temporarily save a parameter required for various types of processing utilized for the CPU 301 to execute a control program. The image memory 306 stores the image data to be formed on the printing medium.

Additionally, as the configuration of the control system, the image formation apparatus 1 includes an interface control circuit 307, a motor control circuit 309, a head control circuit 313, a sensor control circuit 314, and a scanner control circuit 324. The CPU 301 can receive job data to perform printing from a host computer 308 connected by way of an external interface by controlling the interface control circuit 307. Alternatively, the CPU 301 can also notify the host computer 308 connected by way of the external interface of the status of the image formation apparatus 1 by controlling the interface control circuit 307. The CPU 301 can control various motors that drive the structure of the image formation apparatus 1 via the motor control circuit 309. The various motors include, for example, a conveyance motor 310, a carriage motor 311 (also referred to as a CR motor 311), and a recovery motor 312. The conveyance motor 310 drives a feed roller, a conveyance roller, and a discharge roller provided inside the housing 100 to convey the printing medium from the feed unit to the discharge tray 105. The CR motor 311 performs reciprocal driving of a carriage holding the printing head 330. The recovery motor 312 drives a head recovery structure and executes a recovery operation to maintain a proper state of the printing head 330 by performing control in synchronization with the driving of the carriage. The CPU 301 can control the printing head 330 via the head control circuit 313. The image formation on the printing medium is performed by controlling the printing head 330 in synchronization with the reciprocal operation of the carriage. The CPU 301 can control a sensor light source 341 of a sheet sensor 340 via the sensor control circuit 314 and obtain an output voltage of an optical sensor 343. Cassette sensors 326 and 327 are formed of a photointerrupter and a mechanical switch. The cassette sensors 326 and 327 can detect insertion or removal of the feed unit by the user, and the CPU 301 can obtain the detection via the sensor control circuit 314. The CPU 301 controls the operation unit 120 via the panel control circuit 317. The CPU 301 can display desired information on the display unit 230 arranged on the operation unit 120 and monitor the operation of the operation button 210 on the operation unit 120 by the user. The CPU 301 can control the scanner 325 via the scanner control circuit 324 and can read the document image placed on the platen glass 101. The CPU 301 can read and write various files in the memory card 323 mounted in the memory card slot 110 via the memory card control circuit 321. The image read by the scanner 325 is stored into the image memory 306 in the data memory 304, and thereafter the image can be transmitted to the host computer 308 and saved in the memory card 323 as an image file. Additionally, it is also possible to utilize the printing function as a copy function by printing the image read by the scanner 325, without changing, by controlling the printing structure. Note that, the CPU 301 may have the form of a microprocessor formed of a single microchip, or the CPU 301 may have the form of a central processing apparatus in cooperation with another CPU.

### Printing Setting Information

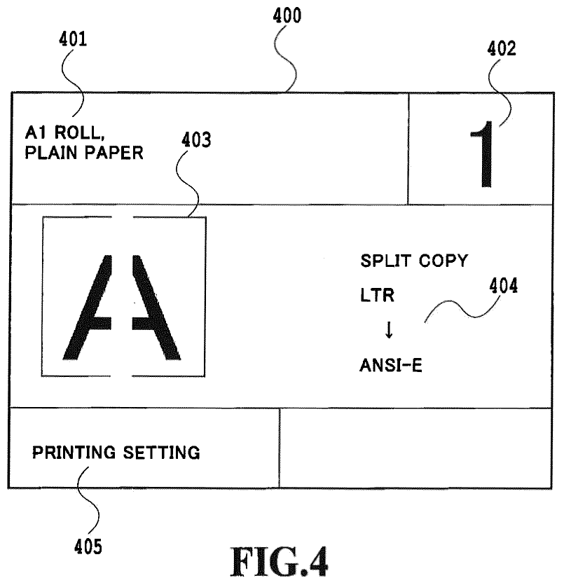

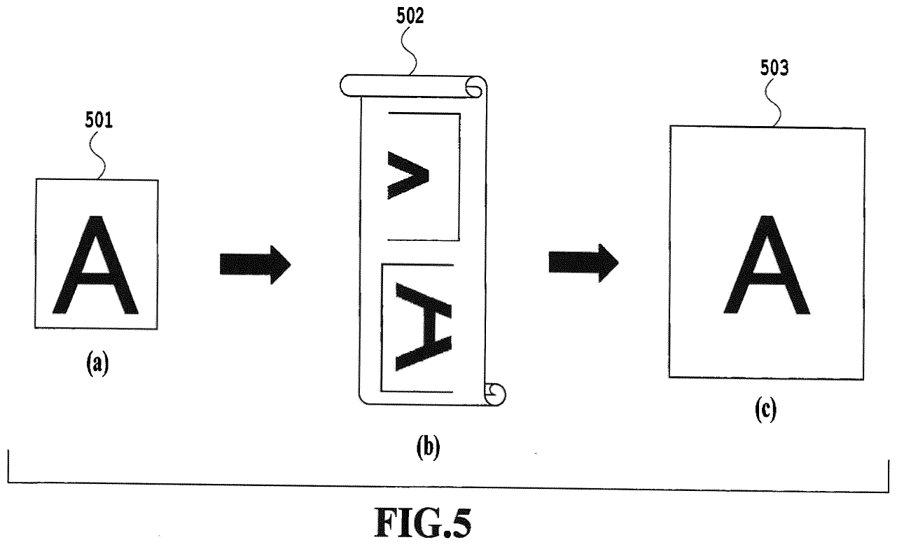

FIG. 4 is a diagram illustrating a display example of the display unit 230 in FIG. 2. In an example in FIG. 4, a use case in which the user selects a copy function via the GUI displayed on the display unit 230, and the user selects enlarged printing setting from options of types of the copy function is assumed. A window 400 includes multiple panes. The multiple panes display printing setting information set by the user. The printing setting information includes printing medium information, printing number information, and size information after enlarged printing. The multiple panes are arranged upper left, upper right, center, and lower left, respectively. In the pane arranged upper left, printing medium information 401 including the size and the sheet type of the roll paper on which the printing is performed is displayed. In the example in FIG. 4, the printing medium information 401 indicating that the size of the roll paper is the A1 roll paper and the sheet type is plain paper is displayed in the upper left pane. In the upper right pane, printing number information 402 is displayed. In the example in FIG. 4, the printing number information 402 indicating that the printing number is one is displayed in the upper right pane. In the central pane, a printing icon 403 and an output size 404 are displayed. The printing icon 403 is set based on the setting information of the enlarged printing setting. The printing icon 403 is illustrated as an icon that imitates a split position and the split number of a cut paper document image. For example, the printing icon 403 indicates an example of splitting the cut paper document image into halves on a short side. Additionally, the cut paper document image used for the printing icon 403 may not be a document image to be duplication-printed as long as it can intuitively indicate the split position and the split number. That is, the printing icon 403 may be any image as long as it is an icon image that imitates an aspect of the split document image. The output size 404 indicates the size information after enlarged printing based on the printing medium information. The output size 404 indicates that the cut paper document image in LTR is enlarged-printed to obtain a final deliverable in ANSI-E. In the lower left pane, a printing setting button 405 to switch the enlarged printing setting is displayed. With the user pressing the printing setting button 405, it is possible to allow the current window 400 to transition to a window to update the printing setting information. (Split Into Halves and Enlarged Printing) FIG. 5 is a diagram schematically describing a series of steps from splitting the document into halves, enlarged-printing and pasting together the split images, and generating the final deliverable by the image formation apparatus 1 in FIG. 1. FIG. 5(a) is a diagram illustrating an example of the cut paper document image generated with the scanner 325 reading the cut paper document. FIG. 5(b) is a diagram illustrating an example of the split and enlarged cut paper document image in FIG. 5(a). FIG. 5(c) is a diagram illustrating an example of the final deliverable obtained by pasting the enlarged printed images in FIG. 5(b) together. Note that, FIG. 5 does not accurately reflect an enlargement ratio. FIG. 5 is used as a diagram intuitively indicating the split enlargement printing. In this case, a use case in which the cut paper document image in A4 is split into halves on a long side, enlarged printing on the roll paper in A1 is then performed, and the enlarged-printed images are pasted together to obtain the final deliverable in A0 is assumed. In this use case, each image of the document after being split into halves fits within a width of the roll paper in Al. Therefore, it is possible to obtain the final deliverable in A0 while maintaining a width-to-height ratio (also referred to as an aspect ratio) of the cut paper document image by pasting the images of the document after being split into halves together. However, in a case where each image of the document after being split into halves does not fit within the width of the roll paper in A1, in order to maintain the aspect ratio of the cut paper document image, it is necessary to split the cut paper document in A4 into thirds, not into halves, on the long side. Next, an example of splitting the cut paper document in A4 into thirds on the long side is described.

### Split Into Thirds and Enlarged Printing

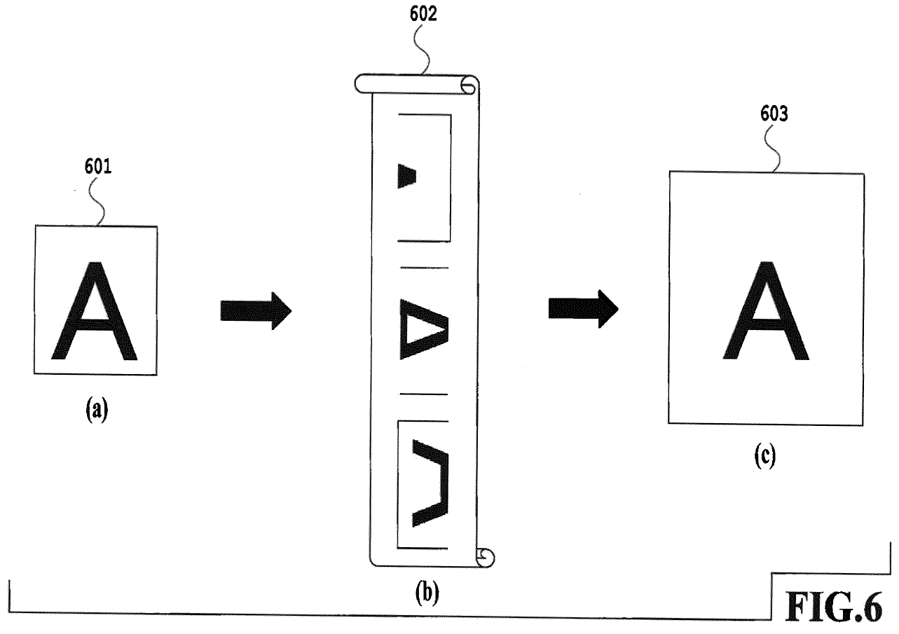

FIG. 6 is a diagram schematically describing a series of steps from splitting the document into thirds, enlarged-printing and pasting together the split images, and generating the final deliverable by the image formation apparatus 1 in FIG. 1. FIG. 6(a) is a diagram illustrating an example of the cut paper document image generated with the scanner 325 reading the cut paper document. FIG. 6(b) is a diagram illustrating an example of the split and enlarged cut paper document image in FIG. 6(a). FIG. 6(c) is a diagram illustrating an example of the final deliverable obtained by pasting the enlarged printed images in FIG. 6(b) together. Note that, FIG. 6 does not accurately reflect the enlargement ratio. FIG. 6 is used as a diagram intuitively indicating the split enlargement printing. In this case, a use case in which the cut paper document image in A4 is split into thirds on the long side, enlarged printing on the roll paper in A1 is then performed, and the enlarged-printed images are pasted together to obtain the final deliverable in A0 is assumed. In this use case, each image of the document after being split into thirds fits within the width of the roll paper in A1. Therefore, it is possible to obtain the final deliverable in A0 while maintaining the aspect ratio of the cut paper document image by pasting the images of the document after being split into thirds together. Note that, also in a case of splitting into fourth or more, if the image of the document after being split fits within the width of the roll paper in A1 but the image of the document split into halves does not fit, it is favorable to split the document into thirds in terms of preventing waste of the roll paper.

### Enlarged Printing on Roll Paper

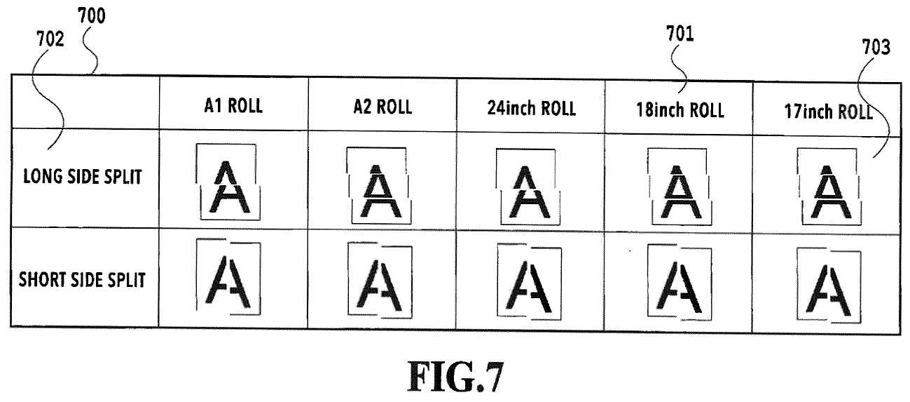

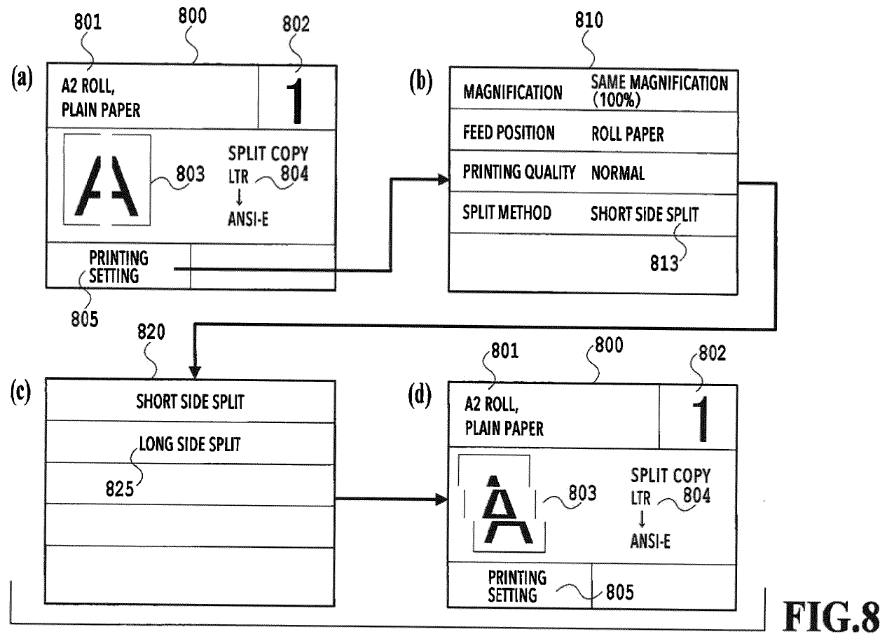

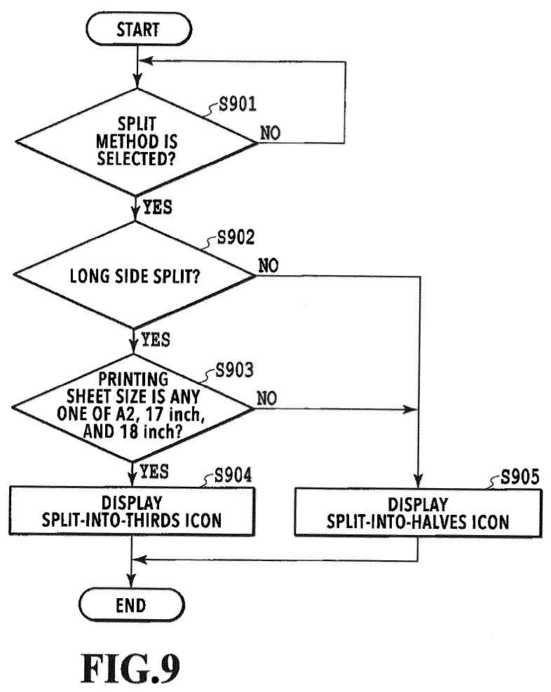

FIG. 7 is a diagram illustrating a combination example of the roll paper size and the split enlargement method used in the enlarged printing. Note that, the A0 size is 841 mm*1189 mm. The A4 size is 210 mm*297 mm. The roll paper width of the A1 roll paper is 594 mm. The roll paper width of the A2 roll paper is 420 mm. The roll paper width of the 24 inch roll paper is 609.6 mm. The roll paper width of the 17 inch roll paper is 431.8 mm. As illustrated in FIG. 7, the type of splitting includes long side split and short side split. Additionally, the long side split includes the split into halves and the split into thirds. In FIG. 7, the A2 roll paper, the 18 inch roll paper, and the 17 inch roll paper are use cases of the split into thirds. That is, in a case where the cut paper document in A4 is split into halves on the long side, and then enlarged printing is performed on the A2 roll paper, the 18 inch roll paper, and the 17 inch roll paper, the image of the document after being split into halves does not fit within the width of each roll paper, which is the A2 roll paper, the 18 inch roll paper, or the 17 inch roll paper. The meaning of the fact that the image of the document after being split into halves does not fit is that the aspect ratio of the final deliverable in A0 cannot be maintained to be the aspect ratio of the cut paper document in A4. A correlation diagram 700 in FIG. 7 illustrates a correlation between the roll paper size and the split enlargement method. The correlation diagram 700 includes a roll paper size pattern 701, a split enlargement method pattern 702, and a printing icon 703. The roll paper size pattern 701 includes patterns of the A1 roll paper, the A2 roll paper, the 24 inch roll paper, the 18 inch roll paper, and the 17 inch roll paper. The split enlargement method pattern 702 includes the long side split and the short side split. The printing icon 703 is an icon determined based on the roll paper size pattern 701 and the split enlargement method pattern 702, which displays how the document is enlarged _and split in the form of an icon. Next, based on FIG. 7, a display example of the split number determined for each split setting is described with reference to FIGS. 8 and 9.

FIG. 8 is a diagram illustrating a display switch example of a printing icon 803 in a case of switching from short side split setting to long side split setting. FIG. 8(a) is a diagram illustrating an example of a window 800 displaying the printing setting information. FIG. 8(b) is a diagram illustrating an example of a printing setting window 810 displayed by which a printing setting button in FIG. 8(a) is pressed. FIG. 8(c) is a diagram illustrating an example of a split method setting window 820. FIG. 8(d) is a diagram illustrating an example of the window 800 after updating the printing setting information. Note that, although it is assumed that the display unit 230 in FIG. 2 corresponds to the GUI in the present embodiment, it is not particularly limited thereto. The display unit 230 in FIG. 2 may correspond to a character user interface (CUI). In this case, a display item may be appropriately selected by a not-illustrated hardware key. Thus, it is possible to update the printing setting also with a simple user interface (UI) such as the CUI. Additionally, the simple UI such as the CUI is also compatible with an IoT device that is requested to reduce the power consumption.

In the example in FIG. 8(a), the printing setting information is displayed via the GUI similar to that in the example in FIG. 4. For example, in the upper left pane, printing medium information 801 indicating that the size of the roll paper is the A2 roll paper and the sheet type is the plain paper is displayed. In the upper right pane, printing number information 802 indicating that the printing number is one is displayed. In the. central pane, the printing icon 803 and an output size 804 are displayed. The printing icon 803 indicates an example of splitting the cut paper document image into halves on the short side. The output size 804 indicates that the cut paper document image in LTR is enlarged-printed to obtain the final deliverable in ANSI-E. In the lower left pane, a printing setting button 805 is displayed. The printing setting window 810 in FIG. 8(b) is displayed by pressing the printing setting button 805.

In the example in FIG. 8(b), the current printing setting information is displayed in the printing setting window 810. The printing setting window 810 includes a magnification menu, a feed position menu, a printing quality menu, and a split method menu 813. With reference to the magnification menu, a magnification is set to the same magnification. With reference to the feed position menu, a feed position is set to a position of the roll paper. With reference to the printing quality menu, the printing quality is set to normal. With reference to the split method menu 813, the split method is set to the short side split. The split method setting window 820 in FIG. 8(c) is displayed with the user selecting the split method menu 813.

In the example in FIG. 8(c), selectable split methods are displayed in the split method setting window 820 as a split method list. The split method list indicates an item of the short side split and an item 825 of the long side split as options. The window 800 in FIG. 8{d) is displayed by selecting the item 825. The printing icon 803 in FIG. 8(d) is displayed in an aspect of the split into thirds on the long side.

FIG. 9 is a flowchart describing display processing of the printing icon according to the selection in FIG. 8. The processing illustrated in FIG. 9 is executed in a timing in which the window 800 displaying the printing setting information is operated. Note that, a part of or all the functions of steps in FIG. 9 may be implemented by hardware such as an ASIC or an electronic circuit. A sign 11S″ in description of each processing means that it is a step in the flowchart. Additionally, it is assumed that the size of the roll paper on which the enlarged printing is performed and the size of the final deliverable are set in advance.

In S901, the CPU 301 determines whether the split method is selected. The split method includes the long side split and the short side split. Since the short side split is processing to split the document image into halves on the short side, the image fits within a width direction of the roll paper selected in advance, and therefore it is possible to obtain the final deliverable while maintaining the aspect ratio of the document image. On the other hand, the long side split is processing to split the document image on the long side, and the split into halves is tried first. In a case where the size obtained by splitting into halves does not fit within the width direction of the roll paper selected in advance, it is impossible to obtain the final deliverable while maintaining the aspect ratio of the document image. In this case, the split into thirds is tried. Therefore, since the subsequent processing is changed depending on the split method selected by the user, first, the CPU 301 determines whether the user selects the split method. If the split method is determined, the CPU 301 allows the processing in S901 to proceed to processing in S902. If no split method is determined, the CPU 301 continues the processing in S901. The CPU 301 performs the processing in S991 according to an operation content of the user on the split method setting window 820 in FIG. 8(c).

In S902, the CPU 301 determines whether the split method is the long side split. If it is the long side split, as illustrated in FIG. 7, either the split into halves or the split into thirds is determined depending on the roll paper size. If it is determined that the split method is the long side split, the CPU 301 allows the processing in S902 to proceed to processing in S903. In S903, the CPU 301 determines whether the printing sheet size is the A2 roll paper, the 17 inch roll paper, or the 18 inch roll paper. If it is determined that the printing sheet size is any one of the A2 roll paper, the 17 inch roll paper, and the 18 inch roll paper, the CPU 301 allows the processing in S903 to proceed to processing in S904. In S904, the CPU 301 displays the printing icon in the state of the split into thirds and ends the processing. If it is determined that the printing sheet size is none of the A2 roll paper, the 17 inch roll paper, and the 18 inch roll paper, the CPU 301 allows the processing in S903 to proceed to processing in S905. That is, the CPU 301 extracts the printing sheet size that cannot be split into halves by the long side split by the processing in S903 so as to perform the processing by splitting into halves on the printing sheet size that can be split into halves and perform the processing by splitting into thirds only in the minimum number of cases.

On the other hand, if it is determined that the split method is not the long side split, the CPU 301 allows the processing in S902 to proceed to the processing in S905. In S905, the CPU 301 displays the printing icon in the state of the split into halves and ends the processing. That is, processing in a case of the short side split is executed.

### Notification Aspect

Note that, in each processing in S904 and S905, the user is notified of the split number by displaying a printing icon 1003; however, it is possible to notify the user of the split number also with another aspect. For example, the user may be notified of the split number by sound. In this case, a sound synthesis function and a speaker may be incorporated in the image formation apparatus 1. Alternatively, the operation unit 120 may oscillate by the split number. In this case, an oscillator may be provided inside the operation unit 120. Alternatively, a device such as a smartphone held by the user may be notified of information of the split number with e-mail. In this case, an e-mail transmission function may be incorporated in the image formation apparatus I. Alternatively, the user may be notified of the split number by the output number of a buzzer. In this case, the buzzer may be provided to the image formation apparatus 1. In short, the image formation apparatus 1 may have a notification function to notify the user of the split number before the split enlargement of the document image and the duplication printing of the document image on the printing medium.

### Effect

In the technique described in PTL 1, there is a possibility that the printing is not performed with the desired split number in a case of the duplication printing, and reprinting is performed in some cases. Therefore, the CPU 301 determines the split number of the document image required for the split enlargement of the document image and the duplication of the image on the printing medium based on the size of the printing medium. Before the duplication, the CPU 301 notifies the user of the determined split number. Since the notified split number is determined based on the size of the printing medium, it is possible to notify of the accurate split number. Accordingly, the CPU 301 can avoid reprinting.

### Second Embodiment

In the first embodiment, an example in which the printing icon for each split number determined based on the printing setting information in FIG. 4 is displayed is described. In a second embodiment, an example in which the user purposely changes the split number is described. Note that, a different point from the first embodiment is mainly described, and description of a configuration similar to that of the first embodiment is omitted as needed.

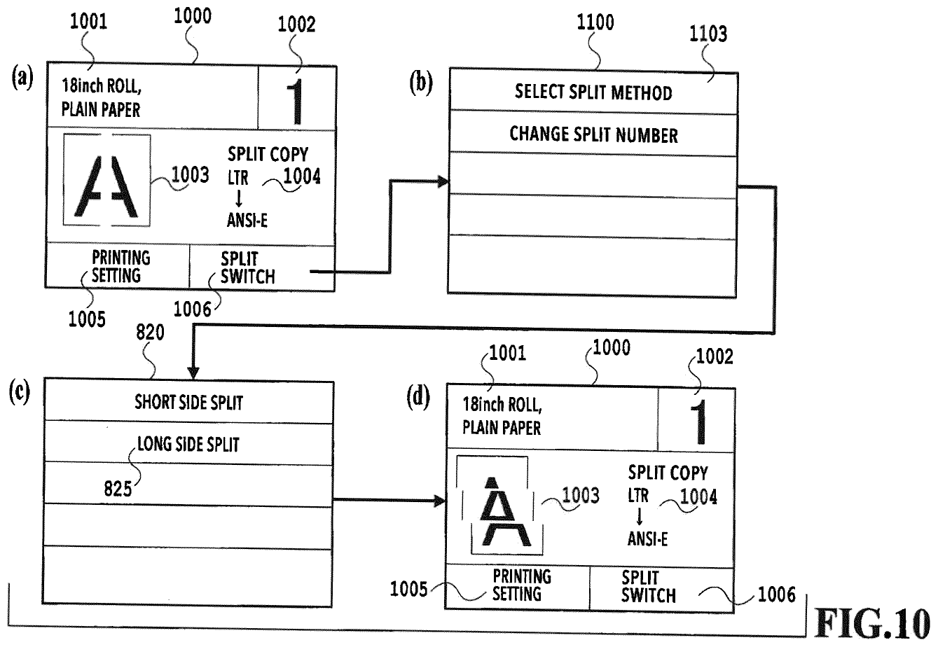

FIG. 10 is diagram illustrating a display switch example of the printing icon according to the second embodiment. In the second embodiment, a use case in which the split method is changed as a means for the user to purposely change the split number is described. Note that, a use case in which the printing sheet size is changed as a means for the user to purposely change the split number is described in a third embodiment. Additionally, a use case in which the user is encouraged to change either of the split method and the printing sheet size is described in a fourth embodiment.

FIG. 10(a) is a diagram illustrating an example of a window 1000 displaying the printing setting information. FIG. 10(b) is a diagram illustrating an example of a setting item window 1100 displayed by which a split switch button in FIG. 10(a) is pressed. FIG. 10(c) is a diagram illustrating an example of the split method setting window 820. FIG. 10(d) is a diagram illustrating an example of the window 1000 after updating the printing setting information.

In the example in FIG. 10(a), the printing setting information is displayed via the GUI similar to that in the example in FIG. 8 except the split switch button 1006. For example, in the upper left pane, printing medium information 1001 indicating that the size of the roll paper is the 18 inch roll paper and the sheet type is the plain paper is displayed. In the upper right pane, printing number information 1002 indicating that the printing number is one is displayed. In the central pane, a printing icon 1003 and an output size 1004 are displayed. The printing icon 1003 indicates an example of splitting the cut paper document image into halves on the short side. The output size 1004 indicates that the cut paper document image in LTR is enlarged-printed to obtain the final deliverable in ANSI-E. In the lower left pane, a printing setting button 1005 is displayed. In the lower right pane, the split switch button 1006 is displayed. The setting item window 1100 in FIG. 10(b) is displayed by pressing the split switch button 1006. The setting item window 1100 includes a change menu 1103. In the change menu 1103, a list of switch methods is displayed. In the list, an item to select the split method and an item to change the split number are indicated as options. The split method setting window 820 in FIG. 10(c) is displayed by selecting the item to select the split method.

In the example in FIG. 10(c), the selectable split methods are displayed in the split method setting window 820 as the split method list. The split method list indicates the item of the short side split and the item 825 of the long side split are indicated as the options. The window 1000 in FIG. 10(d) is displayed by selecting the item 825. The printing icon 1003 in FIG. 10(d) is changed to be displayed in the aspect of the split into thirds on the long side in an icon display region in the central pane.

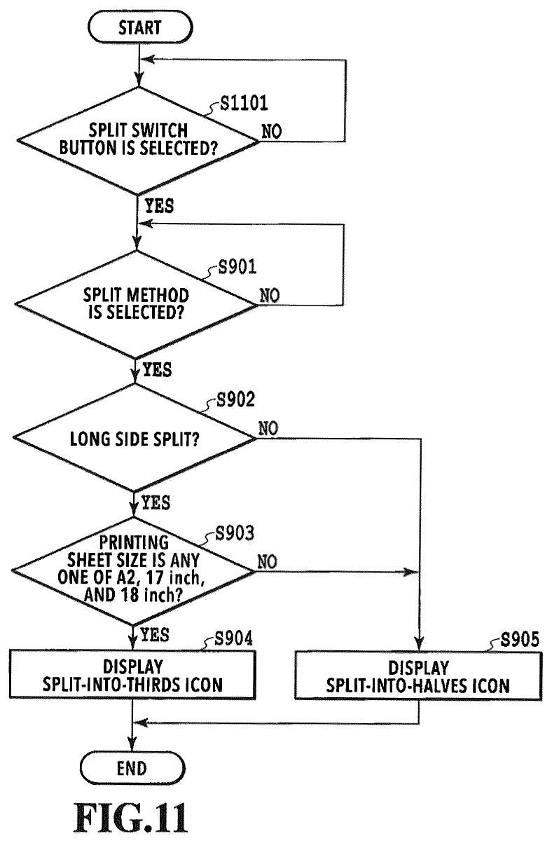

FIG. 11 is a flowchart describing display processing of the printing icon according to the selection in FIG. 10. The processing illustrated in FIG. 11 is executed in a timing in which the window 1000 displaying the printing setting information is operated. Note that, a part of or all the functions of steps in FIG. 11 may be implemented by hardware such as an ASIC or an electronic circuit. A sign “S” in description of each processing means that it is a step in the flowchart. Additionally, it is assumed that the size of the roll paper on which the enlarged printing is performed and the size of the final deliverable are set in advance. Moreover, in the processing illustrated in FIG. 11, the processing in and after S1101 is similar to the processing illustrated in FIG. 9; for this reason, description thereof is omitted.

In S1101, the CPU 301 determines whether the split switch button 1006 is selected. If it is determined that the split switch button 1006 is selected, the CPU 301 allows the processing in S1101 to proceed to the processing in S901. If it is determined that the split switch button 1006 is not selected, the CPU 301 continues the processing in S1101.

### Effect

According to the above description, the split switch button 1006 to switch between the long side and the short side in a case of performing the split enlargement may be further included. If it is determined that the split switch button 1006 is selected, the CPU 301 may execute the processing illustrated in FIG. 9. According to the processing as described above, the user also can purposely change the split number.

### Third Embodiment

In the second embodiment, a use case in which the split method is changed as a means for the user to purposely change the split number. In the third embodiment, a use case in which the user purposely changes the split number from the split into halves to the split into thirds is described. Note that, a different point from the first and second embodiments is mainly described, and description of a configuration similar to that in the first and second embodiments is omitted as needed.

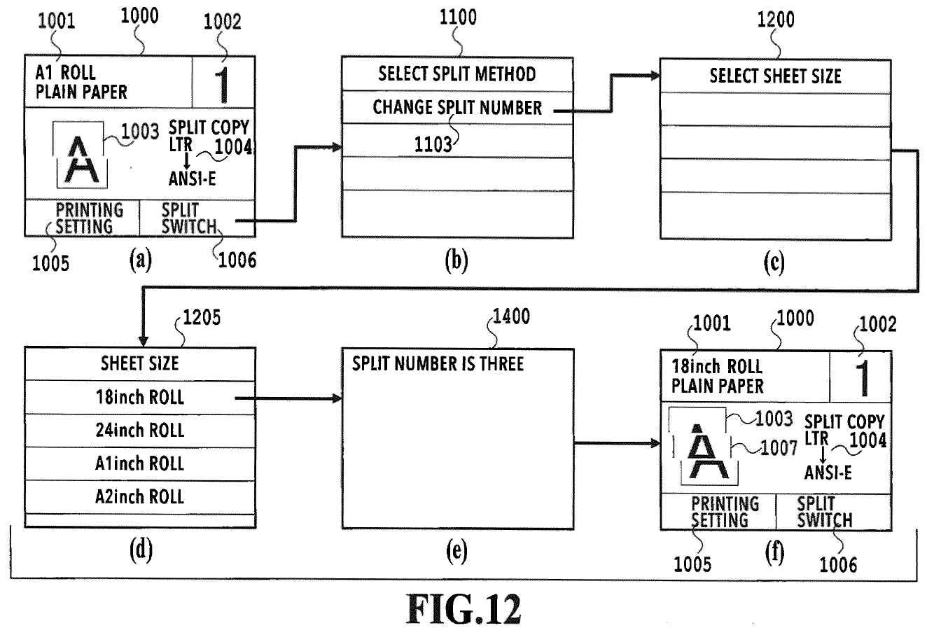

FIG. 12 is a diagram illustrating a display switch example of the printing icon according to the third embodiment. In the third embodiment, a use case in which the printing sheet size is changed as a means for the user to purposely change the split number is described.

FIG. 12(a) is a diagram illustrating an example of the window 1000 displaying the printing setting information. FIG. 12(b) is a diagram illustrating an example of the setting item window 1100 displayed by which the split switch button in FIG. 12(a) is pressed. FIG. 12(c) is a diagram illustrating an example of a split number change window 1200. FIG. 12(d) is a diagram illustrating an example of a printing sheet size setting window 1205. FIG. 12(e) is a diagram illustrating an example of a split number display window 1400. FIG. 12(f) is a diagram illustrating an example of the window 1000 after updating the printing setting information.

In the example in FIG. 12(a), the printing setting information is displayed in the window 1000 via the GUI similar to that in the example in FIG. 10(a). For example, in the upper left pane, the printing medium information 1001 indicating that the size of the roll paper is the A1 roll paper and the sheet type is the plain paper is displayed. In the upper right pane, the printing number information 1002 indicating that the printing number is one is displayed. In the central pane, the printing icon 1003 and the output size 1004 are displayed. The printing icon 1003 indicates an example of splitting the cut paper document image into halves on the long side. The output size 1004 indicates that the cut paper document image in LTR is enlarged-printed to obtain the final deliverable in ANSI-E. In the lower left pane, the printing setting button 1005 is displayed. In the lower right pane, the split switch button 1006 is displayed. The setting item window 1100 in FIG. 12(b) is displayed by pressing the split switch button 1006. The setting item window 1100 includes the change menu 1103. In the change menu 1103, the list of the switch methods is displayed as with FIG. 10(b). The split number change window 1200 in FIG. 12(c) is displayed by selecting the item to change the split number.

In the example in FIG. 12(c), an item of “select sheet size” is displayed in the split number change window 1200 as an option. The printing sheet size setting window 1205 in FIG. 12(d) is displayed by selecting the item of “select sheet size.” In the example in FIG. 12(d), a list of selectable sheet sizes is displayed in the printing sheet size setting window 1205. The split number display window 1400 in FIG. 12(e) is displayed by selecting the sheet size from the list of the selectable sheet sizes. For example, in a case where the 18 inch roll paper is selected from the 18 inch roll paper, the 24 inch roll paper, the A1 inch roll paper, and the A2 inch roll paper, a message indicating “split number is three” is displayed in the split number display window 1400. After the split number display window 1400 is displayed, the window 1000 in FIG. 12(f) is displayed. The printing icon 1003 in FIG. 12(f) is changed to be displayed in the aspect of the split into thirds on the long side. Note that, the split number may be displayed for each sheet size in the printing sheet size setting window 1205 in FIG. 12(d) without displaying the split number display window 1400 in FIG. 12(e).

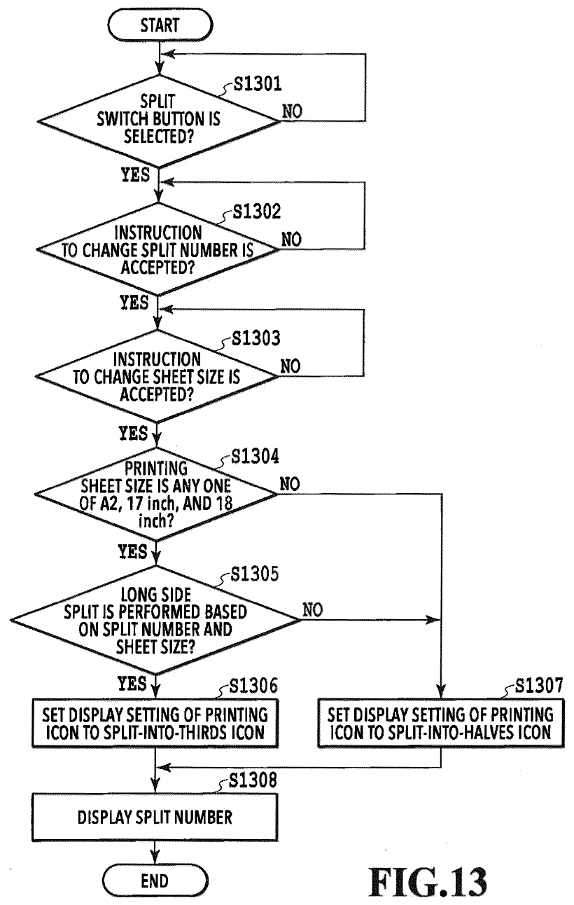

FIG. 13 is a flowchart describing display processing of the printing icon according to the selection in FIG. 12. The processing illustrated in FIG. 13 is executed in a timing in which the window 1000 displaying the printing setting information is operated. Note that, a part of or all the functions of steps in FIG. 13 may be implemented by hardware such as an ASIC or an electronic circuit. A sign 11S″ in description of each processing means that it is a step in the flowchart. Additionally, it is assumed that the size of the roll paper on which the enlarged printing is performed and the size of the final deliverable are set in advance.

In S1301, the CPU 301 determines whether the split switch button 1006 is selected. If it is determined that the split switch button 1006 is selected, the CPU 301 allows the processing in S1301 to proceed to processing in S1302. If it is determined that the split switch button 1006 is not selected, the CPU 301 continues the processing in S1301. For example, in a case where the split switch button 1006 in the window 1000 in FIG. 12(a) is pressed, the setting item window 1100 in FIG. 12(b) is displayed.

In S1302, the CPU 301 determines whether an instruction to change the split number is accepted. If it is determined that the instruction to change the split number is accepted, the CPU 301 allows the processing in S1302 to proceed to processing in S1303. If it is determined that the instruction to change the split number is not accepted, the CPU 301 continues the processing in S1302. For example, in a case where the item to change the split number in the setting item window 1100 in FIG. 12(b) is selected, the split number change window 1200 in FIG. 12(c) is displayed, and the CPU 301 proceeds to processing to select the sheet size.

In S1303, the CPU 301 determines whether an instruction to change the sheet size is accepted. If it is determined that the instruction to change the sheet size is accepted, the CPU 301 allows the processing in S1303 to proceed to processing in S1304. If it is determined that the instruction to change the sheet size is not accepted, the CPU 301 continues the processing in S1303. For example, in a case where the item of select sheet size'1 in FIG. 12(c) is selected, the printing sheet size setting window 1205 in FIG. 12(d) is displayed.

In S1304, the CPU 301 determines whether the printing sheet size is any one of A2, 17 inch, and 18 inch. If it is determined that the printing sheet size is any one of A2, 17 inch, and 18 inch, the CPU 301 allows the processing in S1304 to proceed to processing in S1305. In this case, each roll paper of A2, 17 inch, and 18 inch can be split into halves by the short side split; however, in a case of the long side split, the document needs to be split into thirds to maintain the aspect ratio between the document image and the final deliverable. In S1305, the CPU 301 determines whether the long side split is performed based on the split number and the sheet size. If it is determined that the long side split is performed based on the split number and the sheet size, the CPU 301 allows the processing in S1305 to proceed to processing in S1306. In S1306, the CPU 301 sets the display setting of the printing icon to the icon of the split into thirds and allows the processing in S1306 to proceed to S1308. If it is determined that the long side split is not performed based on the split number and the sheet size, the CPU 301 allows the processing in S1305 to proceed to processing in S1307.

In this case, in S1304, if it is determined that the printing sheet size is one of A2, 17 inch, and 18 inch, the CPU 301 allows the processing in S1304 to proceed to processing in S1307. In S1307, the CPU 301 sets the display setting of the printing icon to the icon of the split into halves and allows the processing in S1307 to proceed to processing in S1308. In S1308, the CPU 301 displays the split number and ends the processing. The split number is displayed by, for example, displaying a character as illustrated in FIG. 12(e).

### Effect

According to the above description, in a case where the size of the printing medium is changed, the display of the icon image may be changed according to the change of the size. According to the processing as described above, since the display of the icon image is also changed according to the change of the size, this also allows the user to purposely change the split number.

### Fourth Embodiment

In the third embodiment, a use case in a case where the user purposely changes the split number in which the printing sheet size is changed and the split number is switched from the split into halves to the split into thirds is described. In the fourth embodiment, a use case in a case where the user purposely changes the split number in which the printing sheet size is changed and the split number is switched from the split into thirds to the split into halves is described. As a configuration of changing the split number from the split into thirds to the split into halves, a configuration of changing based on the split method and the printing sheet size may be applied. Note that, a different point from the first to third embodiments is mainly described, and description of a configuration similar to that in the first to third embodiments is omitted as needed.

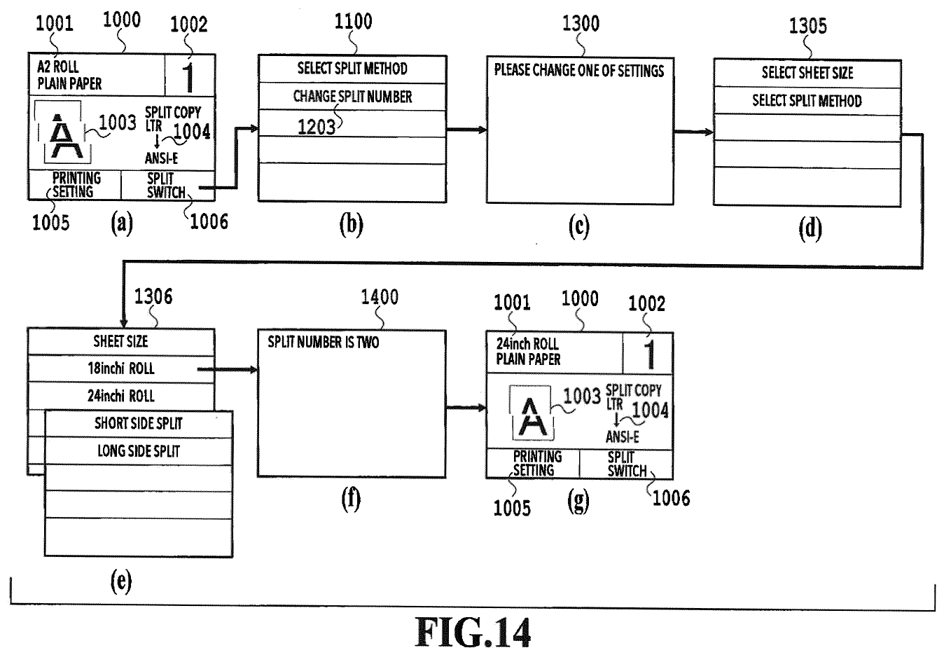

FIG. 14 is a diagram illustrating a display switch example of the printing icon according to the fourth embodiment. In the fourth embodiment, a use case in which the user purposely changes the split number from the split into thirds to the split into halves is described.

FIG. 14(a) is a diagram illustrating an example of the window 1000 displaying the printing setting information. FIG. 14{b) is a diagram illustrating an example of the setting item window 1100 displayed by which the split switch button in FIG. 14(a) is pressed. FIG. 14(c) is a diagram illustrating an example of a setting change guide window 1300. FIG. 14(d) is a diagram illustrating an example of a setting change window 1305. FIG. 14(e) is a diagram illustrating an example of the printing sheet size setting window and the split method setting window. FIG. 14(f) is a diagram illustrating an example of the split number display window 1400. FIG. 14(g) is a diagram illustrating an example of the window 1000 after updating the printing setting information.

In the example in FIG. 14(a), the printing setting information is displayed in the window 1000 via the GUI similar to that in the example in FIG. 12(a). For example, in the upper left pane, the printing medium information 1001 indicating that the size of the roll paper is the A2 roll paper and the sheet type is the plain paper is displayed. In the upper right pane, the printing number information 1002 indicating that the printing number is one is displayed. In the central pane, the printing icon 1003 and the output size 1004 are displayed. The printing icon 1003 indicates an example of splitting the cut paper document into thirds on the long side. The output size 1004 indicates that the cut paper document image in LTR is enlarged-printed to obtain the final deliverable in ANSI-E. In the lower left pane, the printing setting button 1005 is displayed. In the lower right pane, the split switch button 1006 is displayed. The setting item window 1100 in FIG. 14(b) is displayed by pressing the split switch button 1006. The setting item window 1100 includes a change menu 1203. In the change menu 1203, the list of the switch methods is displayed as with FIG. 12(b). With the item to change the split number being selected, the setting change guide window 1300 in FIG. 14(c) is displayed, and thereafter the setting change window 1305 in FIG. 14(d) is displayed. In the setting change guide window in FIG. 14(c), “please change one of settings” is displayed. This is because there are multiple setting items required to change the split number. In a case where the item of “select sheet size” is selected in the setting change window 1305 in FIG. 14(d), the split method setting window similar to that in the second embodiment is displayed in the foreground as one of windows in a window group 1306 in FIG. 14(e). On the other hand, in a case where an item of “select split method” is selected in the setting change window 1305 in FIG. 14(d), the printing sheet size setting window similar to that in the third embodiment is displayed in the foreground as one of windows in the window group 1306 in FIG. 14(e). After the split number display window 1400 in FIG. 14(f) is displayed according to the item selected in the window group 1306 in FIG. 14(e), the window 1000 in FIG. 14(g) is displayed. In the example in FIG. 14(f), “split number is two” is displayed, and in the example in FIG. 14(g), the printing icon 1003 that is changed to indicate that the long side is split into halves is displayed. Note that, in a case where the splitting on the long side and the splitting into halves are possible, only the A1 roll paper or the 24 inch roll paper is available, and thus the GUI may be structured to prevent the other roll paper from being selected. That is, in a case where the sheet size and the split method are selected, processing is executed so as to be subject to the restriction of the correlation diagram 700 in FIG. 7.

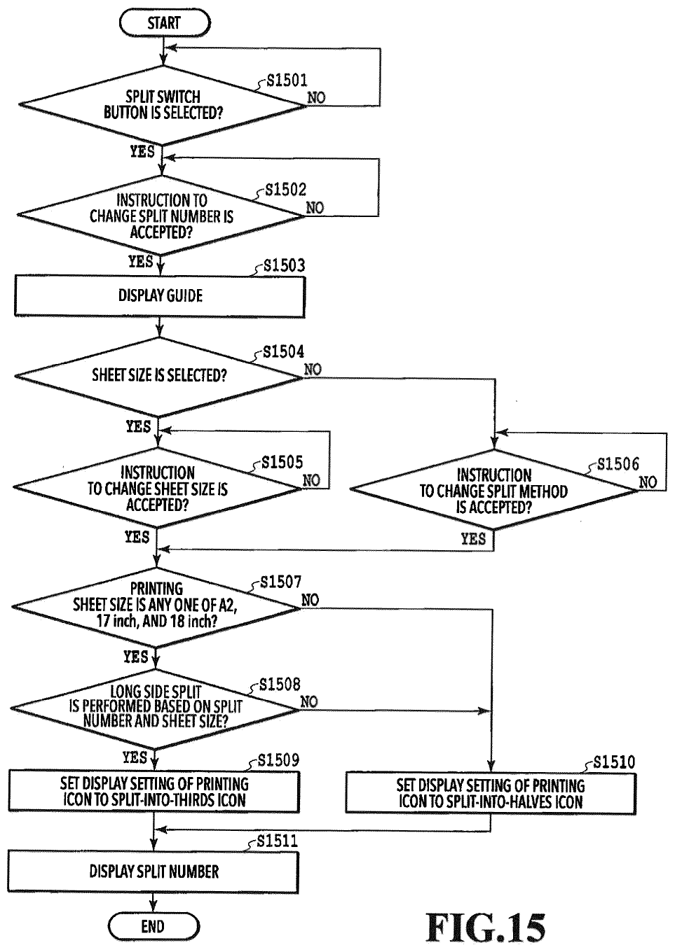

FIG. 15 is a flowchart describing display processing of the printing icon according to the selection in FIG. 14. The processing illustrated in FIG. 15 is executed in a timing in which the window 1000 displaying the printing setting information is operated. Note that, a part of or all the functions of steps in FIG. 15 may be implemented by hardware such as an ASIC or an electronic circuit. A sign “S” in description of each processing means that it is a step in the flowchart. Additionally, it is assumed that the size of the roll paper on which the enlarged printing is performed and the size of the final deliverable are set in advance. Moreover, processing from S1501 to S1502 in FIG. 15 is similar to the processing from S1301 to S1302 in FIG. 13. Processing from S1507 to S1511 in FIG. 15 is similar to the processing from S1304 to S1308 in FIG. 13. Processing from S1503 to S1506 in FIG. 15 is different from the processing in S1303 in FIG. 13.

In S1503, the CPU 301 displays a guide. For example, the setting change guide window 1300 in FIG. 14(c) is displayed. In S1504, the CPU 301 determines whether the sheet size is selected. If it is determined that the sheet size is selected, the CPU 301 allows the processing in S1504 to proceed to processing in S1505. For example, the item of “select sheet size” is selected in the setting change window 1305 in FIG. 14(d), and the sheet size is changed. On the other hand, if it is determined that the sheet size is not selected, the CPU 301 allows the processing in S1504 to proceed to processing in S1506. For example, the item of “select split method” that is an item other than the item of “select sheet size” is selected in the setting change window 1305 in FIG. 14(d), and the split method is changed.

### Effect

According to the above description, in a case where the size of the printing medium is changed, the CPU 301 may notify again of the split number according to the change of the size. Additionally, in a case where the split method is switched to either the long side or the short side, the CPU 301 may notify again the split number according to the switching. According to the above-described processing, the split number is notified again according to the change in the size of the printing medium and the split method, and therefore it is possible to improve the usability.

### Other Embodiments

Although the present disclosure is described above using various examples and embodiments, the intent and the scope of the present disclosure are not limited to a specific description of the present specification. The present disclosure is not limited to the above-described embodiments, and various modifications may be applied. Additionally, the present disclosure may be an appropriate combination of a part of the above-described embodiments.

### Modification 1

For example, although an example in which the roll paper is split as the printing medium is described, it is not particularly limited thereto. For example, a configuration in which the cut paper is split and the enlarged printing to a greater size than the size of the split cut paper may be applied.

### Modification 2

Additionally, although an example in which the size of the sheet before being enlarged is LTR (letter size; 215.9×279.4 mm) and the size of the sheet after being enlarged is ANSI-E (864×1118 mm) is described, it is not particularly limited thereto. For example, the size of the sheet before being enlarged may be A4 (210×297 mm) and the size of the sheet after being enlarged may be A0 (841×1189 mm).

### Modification 3

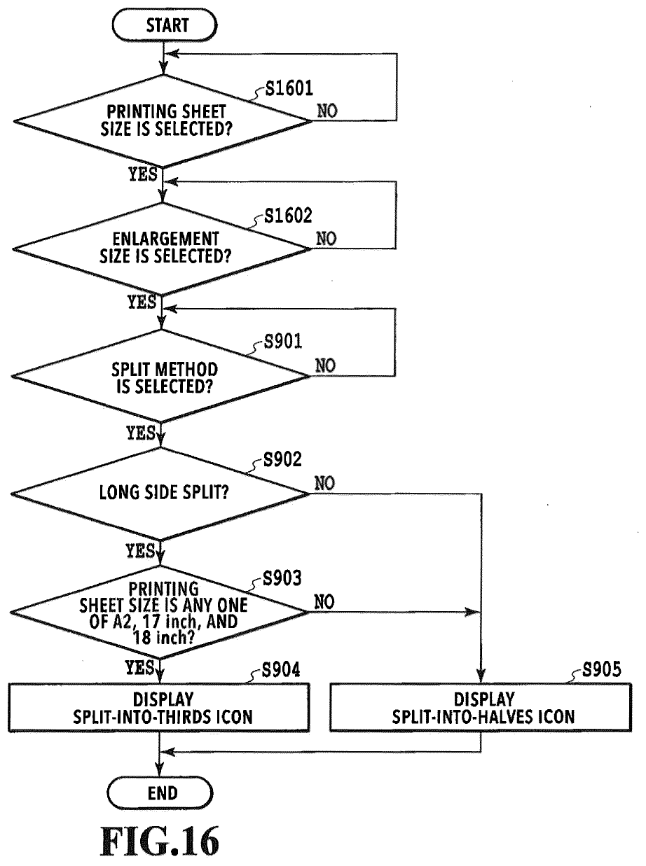

Moreover, although a use case assuming that the printing setting information is selected in advance is described in the first to fourth embodiments, it is unnecessary to be particularly limited thereto. The selection may be performed while executing the processing. FIG. 16 is a flowchart describing display processing of the printing icon according to the modification. Note that, since processing from S901 to S905 in FIG. 16 is similar to the processing from S901 to S905 in FIG. 9, description thereof is omitted.

In S1601, the CPU 301 determines whether the printing sheet size is selected. If it is determined that the printing sheet size is selected, the CPU 301 allows the processing in S1601 to proceed to processing in S1602. The printing sheet size is the size of the printing medium that is an output destination in a case where the document image is enlarged and split and duplication-printed on the printing medium. The printing sheet includes, for example, the roll paper. If it is determined that the printing sheet size is not selected, the CPU 301 continues the processing in S1601. In S1602, the CPU 301 determines whether the enlargement size is selected. If it is determined that the enlargement size is selected, the CPU 301 allows the processing in S1602 to proceed to the processing in S901. The enlargement size is the size of the final deliverable. For example, the final deliverable in A0 is obtained by enlarging and splitting the document image obtained by scanning the cut paper document in A4, duplicating the image on the A1 roll paper, and cutting and pasting together the duplicated images. On the other hand, if it is determined that the enlargement size is not selected, the CPU 301 continues the processing in S1602.

According to the above description, since it is possible to set the printing setting information appropriately as needed even in a case where the printing setting information is not prepared in advance, it is possible to improve the usability.

### Modification 4

Note that, although an example in which the split number is notified according to the correlation diagram 700 in FIG. 7 is described, it is not particularly limited thereto. The size of the document image and whether the split image obtained by enlarging and splitting the document image fits within the width of the printing medium may be obtained in each case. For example, the CPU 301 may perform processing to increase the split number in a case where the split image obtained by enlarging and splitting the document image does not fit within the width of the printing medium. Alternatively, the CPU 301 may determine the split number as two in a case where the split image obtained by enlarging and splitting the document image fits within the width of the printing medium. Alternatively, the CPU 301 may determine the split number as three in a case where the split image obtained by enlarging and splitting the document image does not fit within the width of the printing medium. Alternatively, the CPU 301 may determine that it is a case where the split image does not fit within the width of the printing medium in a case where the width-to-height ratio of the final result obtained by pasting together the multiple duplicated images that are duplicated on the printing medium is different from the width-to-height ratio of the document image

### Modification 5

Additionally, although an example in which the split number is intuitively notified by using the printing icon 803 or the printing icon 1003 or an example in which the split number is notified by using a sentence as illustrated in FIG. 12(e) is described, it is not particularly limited thereto. For example, the split number may be displayed in the central pane of the window 1000. In a case where the user is notified of the split number by displaying the split number in the window 1000, once the user presses the start button 210C of the operation unit 120, the CPU 301 can accept an instruction to execute the duplication printing. That is, the CPU 301 may notify of the split number on the screen displaying the printing setting information. Additionally, the CPU 301 may accept the instruction to execute the duplication printing by pressing the start button 210C in a state in which the split number is displayed on the screen displaying the printing setting information.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the: functions of one or more of the above described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to avoid reprinting.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159207, filed Sep. 13, 2024 which is hereby incorporated by reference herein in its entirety.

What is claimed is:

1. An image formation apparatus comprising:
one or more processors; and
one or more memories storing instructions that, when executed by the one or more processors, cause the image forming apparatus to:
determine a split number of a document image that is required to enlarge and split the document image and perform duplication printing on a printing medium based on a size of the printing medium and a split enlargement direction of the document image; and
notify a user of the split number determined by the determination unit before accepting an instruction to execute the duplication printing.

2. The image formation apparatus according to claim 1, wherein the instructions further cause the image forming apparatus to:
in a case where a split image obtained by enlarging and splitting the document image does not fit within a width of the printing medium, increase the split number.

3. The image formation apparatus according to claim 1, wherein the instructions further cause the image forming apparatus to:
in a case where a split image obtained by enlarging and splitting the document image fits within a width of the printing medium, determine the split number as two, and in a case where the split image obtained by enlarging and splitting the document image does not fit within the width of the printing medium, determine the split number as three.

4. The image formation apparatus according to claim 1, further comprising: the instructions further cause the image forming apparatus to:
cause a display unit to display the split number.

5. The image formation apparatus according to claim 4, wherein the instructions further cause the image forming apparatus to:
as a display of the split number, cause the display unit to display an icon image that imitates an aspect of splitting the document image.

6. The image formation apparatus according to claim 2, wherein the instructions further cause the image forming apparatus to:
in a case where a width-to-height ratio of a final result obtained by pasting together a plurality of duplicated images that are duplicated on the printing medium is different from a width-to-height ratio of the document image, determine that the split image does not fit within the width of the printing medium.

7. The image formation apparatus according to claim 5, wherein the instructions further cause the image forming apparatus to:
perform the split enlargement by splitting the document image on either of a long side and a short side.

8. The image formation apparatus according to claim 5, wherein the instructions further cause the image forming apparatus to:
cause the display unit to change the display of the icon image according to change of the size of the printing medium.

9. The image formation apparatus according to claim 1, wherein the instructions further cause the image forming apparatus to:
notify again of the split number according to change of the size of the printing medium.

10. The image formation apparatus according to claim 7, wherein the instructions further cause the image forming apparatus to:
notify again of the split number according to switching between the long side and the short side.

11. The image formation apparatus according to claim 4, wherein the instructions further cause the image forming apparatus to:
cause the display unit to display the split number on a screen displaying printing setting information used for the duplication printing.

12. The image formation apparatus according to claim 11, further comprising:
a start button configured to accept an operation by the user to perform the duplication printing; and the instructions further case the image forming apparatus to:
accept an instruction to execute the duplication printing by being pressed the start button in a state in which the printing setting information is displayed.

13. An image formation method, comprising:
determining a split number of a document image that is required to enlarge and split the document image and perform duplication printing on a printing medium based on a size of the printing medium and a split enlargement direction of the document image; and
notifying a user of the split number determined by the determining before accepting an instruction to execute the duplication printing.

14. A computer-readable storage medium storing a program causing a computer to execute:
determining a split number of a document image that is required to enlarge and split the document image and perform duplication printing on a printing medium based on a size of the printing medium and a split enlargement direction of the document image; and
notifying a user of the split number before accepting an instruction to execute the duplication printing.
